(19) United States
(12) Patent Application Publication
(10) Pub. No.: US 2018/0372194 A1
(43) Pub. Date: Dec. 27, 2018

(54) ROBOT ARM MECHANISM AND LINEAR EXTENSION AND RETRACTION MECHANISM

(71) Applicant: LIFE ROBOTICS INC., Tokyo (JP)

(72) Inventor: Woo-Keun YOON, Tokyo (JP)

(21) Appl. No.: 16/115,806

(22) Filed: Aug. 29, 2018

Related U.S. Application Data
(63) Continuation of application No. PCT/JP2017/006721, filed on Feb. 23, 2017.

(30) Foreign Application Priority Data
Feb. 29, 2016 (JP) 2016-038464

(51) Int. Cl. F16H 19/06; B25J 18/02; F16G 13/20

(52) U.S. Cl. CPC F16H 19/0636; F16H 19/0645; F16G 13/20; B25J 18/025

(57) ABSTRACT

A linear extension and retraction mechanism provided in a robot arm mechanism includes first and second pieces that are bendably connected, respectively. A sending-out mechanism includes a plurality of rollers that firmly sandwich the first and second pieces and support the first and second pieces movably to front and rear, and a drive gear that is meshed with a linear gear of the first pieces rearward of the rollers, and sends out the first pieces to the front and pulls back the first pieces to the rear. The sending-out mechanism is composed of separate bodies that are a roller unit including rollers, and a drive unit including the drive gear. The drive unit is fixed to a drum body of an up/down section. The roller unit is configured to be detachably attachable to the drive unit.

### CROSS-REFERENCE TO RELATED APPLICATIONS

This application is a continuation application of International Patent Application No. PCT/JP2017/006721 filed on Feb. 23, 2017, which is based upon and claims the benefit of priority from the Japanese Patent. Application No. 2016-038464, filed Feb. 29, 2016 the entire contents of which are incorporated herein by reference.

### FIELD

Embodiments described herein relate generally to a robot arm mechanism and a linear extension and retraction mechanism.

### BACKGROUND

Conventionally, articulated robot arm mechanisms are used in various fields such as the field of industrial robots. The present inventors achieved practical application of a linear extension and retraction mechanism. The linear extension and retraction mechanism is a structure that makes an elbow joint unnecessary and realizes the elimination of singular points, and is thus a structure that will be extremely useful from now on.

The linear extension and retraction mechanism is constituted by a plurality of flat-plate shaped pieces that are bendably connected and a plurality of pieces having an U-shaped groove frame shape that are similarly bendably connected on a bottom side, and a columnar arm section that is made linearly rigid and has a certain rigidity is constituted by these two types of pieces joining together. When a motor of the linear extension and retraction mechanism rotates forward, the arm section in the shape of a columnar body is sent out from a sending-out mechanism, and when the motor rotates backward the arm section is pulled back. The joined state of the pieces is released at the rear of the sending-out mechanism, and the pieces return from the rigid state to a bent state. The two types of pieces that returned to the bent state are bent in the same direction, and are housed in an aligned manner inside a columnar support section.

Along with the two types of pieces, a plurality of rollers that firmly sandwich the two types of pieces is an important structure in the linear extension and retraction mechanism. The rollers are made of, for example, self-lubricating resin, and the rollers receive a load from an arm section and a hand provided in the arm section, as well as from a work piece which is gripped with the hand, and it, can be said that these rollers are the components which are most susceptible to damage and for which the replacement frequency is comparatively high.

### SUMMARY OF INVENTION

### Technical Problem

A purpose of the present invention is to improve work pieceability when replacing rollers that constitute part of a linear extension and retraction mechanism.

### Solution to Problem

In a robot arm mechanism according to the present embodiment, a columnar support section having a turning rotational joint is supported on a base, an up/down section having an upward/downward rotational joint is mounted on the columnar support section, and a linear extension and retraction mechanism including an arm section having linear elasticity is provided in the up/down section. A wrist section to which an end effector is attachable is mounted at a tip of the arm section. At least one rotational joint for changing a posture of the end effector is mounted in the wrist section. The linear extension and retraction mechanism includes a plurality of first pieces having a flat-plate shape, and a plurality of second pieces having a cross-sectional U-shaped groove frame shape. The first pieces are bendably connected to each other at front and rear ends. The plurality of second pieces are bendably connected to each other at front and rear ends of a bottom plate. A leading first, piece of the plurality of first pieces and a leading second piece of the plurality of second pieces are joined by a head section. The first and second pieces become linearly rigid and constitute the arm section when joined together, and the first and second pieces return to a bent state when separated from each other. A sending-out mechanism has a plurality of rollers that firmly sandwich the first and second pieces to secure a joined state of the first and second pieces and that support the first and second pieces movably to front and rear, and a drive gear that is meshed with a linear gear of the separated first pieces rearward of the rollers and that sends out the first pieces to the front and pulls back the first pieces to the rear. The sending-out mechanism is composed of separate bodies which are a roller unit that includes the rollers, and a drive unit that includes the drive gear. The drive unit is fixed to a rotating section of the up/down section. The roller unit is configured to be detachably attachable to the drive unit.

### BRIEF DESCRIPTION OF THE VIEWS OF THE DRAWING

FIG. 1 is an external perspective view of a robot arm mechanism according to the present embodiment;

FIG. 2 is a side view of the robot arm mechanism shown in FIG. 1;

FIG. 3 is a view illustrating an internal structure of the robot arm mechanism in FIG. 1, which is a cross section view;

FIG. 4 is a view illustrating the configuration of the robot arm mechanism in FIG. 1 by representation with graphic symbols; and

FIGS. 5A, 5B, and 5C are perspective views of an arm sending-out mechanism shown in FIG. 3.

### DETAILED DESCRIPTION

Hereinafter, a robot arm mechanism according to the present embodiment is described with reference to the accompanying drawings. Although a polar-coordinate type robot arm mechanism equipped with a linear extension and retraction mechanism is described herein as an example of the robot arm mechanism of the present embodiment, the robot arm mechanism may be of another type.

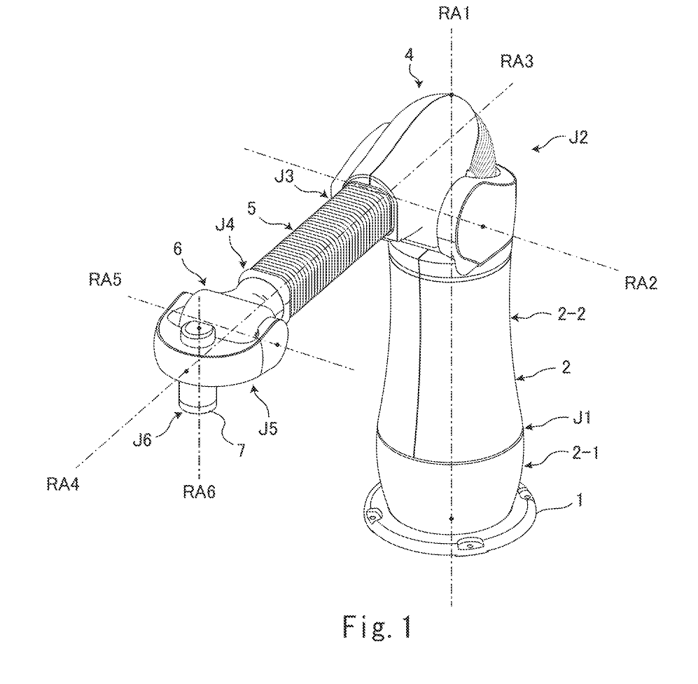

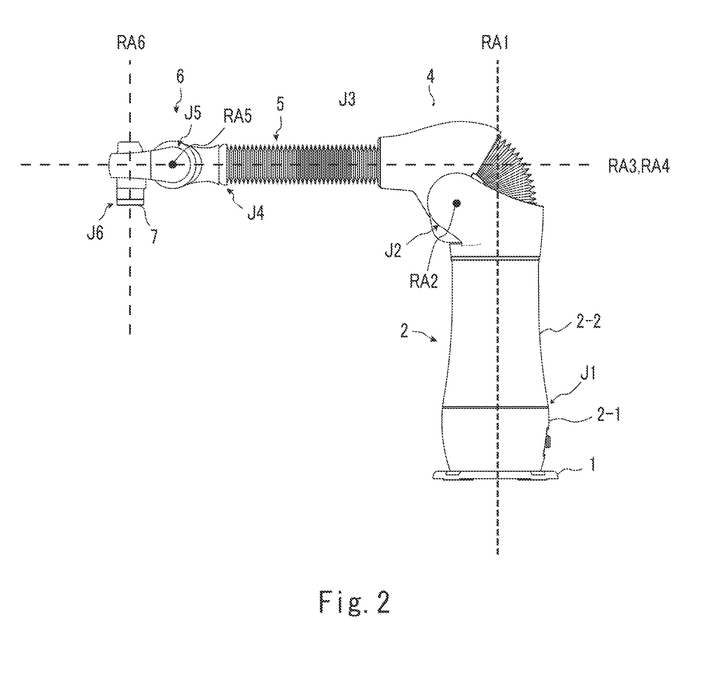

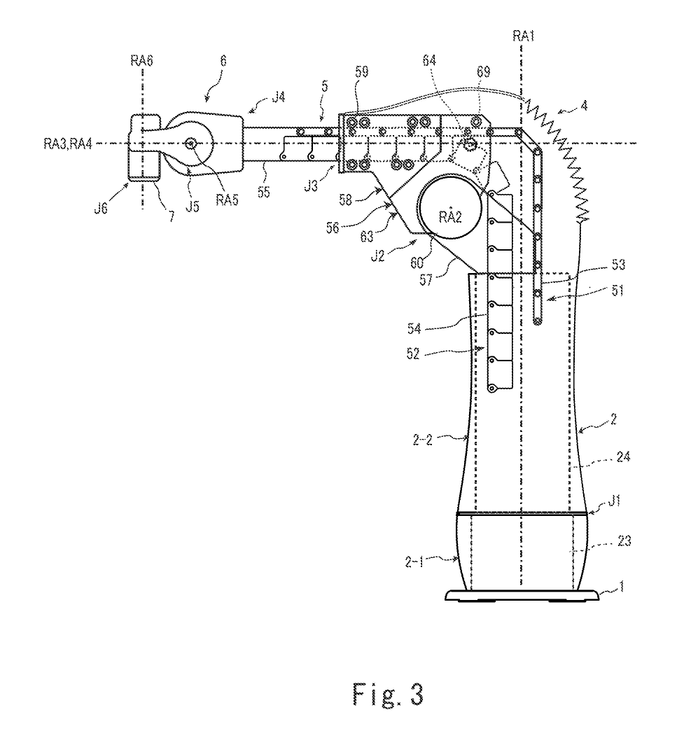

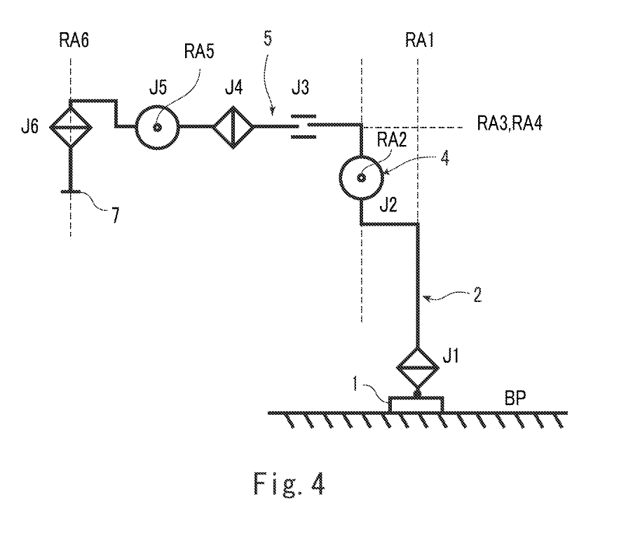

FIG. 1 is a perspective view of the polar-coordinate type robot arm mechanism according to the present embodiment, FIG. 2 is a side view thereof, and FIG. 3 is a side view of the robot arm mechanism from which a side-face cover has been detached. FIG. 4 is a view illustrating the configuration of the robot arm mechanism by representation with graphic symbols. A columnar support section 2 forming a cylindrical body is typically installed vertically on a base 1 of the robot arm mechanism. The columnar support section 2 houses a first, joint J1 as a turning rotational joint. The first joint J1 has an axis of rotation RA1. The axis of rotation RA1 is parallel to the vertical direction. The arm section 5 turns horizontally by rotation of the first joint J1. The columnar support section 2 includes a lower part 2-1 and an upper part 2-2. The lower part 2-1 is connected to a fixed section of the first joint J1. The column upper part 2-2 is connected to a rotating section of the first joint J1, and axially rotates on the axis of rotation RAI. First and second piece strings of the third joint J3 as a linear extension and retraction mechanism that is described later are housed in an inner hollow of the columnar support section 2 that forms a cylindrical body. An up/down section 4 that, houses a second joint J2 as an upward/downward rotational joint is installed in the upper part 2-2 of the columnar support section 2. The second joint. J2 is a bending rotational joint. The axis of rotation RA2 of the second joint J2 is perpendicular to the axis of rotation RAI. The second joint 42 is installed in the upper part 2-2 of the columnar support section 2. The arm section 5 rotates upward and downward vertically by rotation of the second joint J2.

The third joint J3 is provided by a linear extension and retraction mechanism. Although described in detail later, the linear extension and retraction mechanism is equipped with a structure that was newly developed by the present inventors, and is clearly distinguished from a so-called “linear motion joint” from the viewpoint of the movable range thereof. Although the arm section 5 of the third joint. J3 is bendable, the bending is restricted when the arm section 5 is sent out in the forward direction from a sending-out mechanism 56 that is a root of the arm section 5 along a center axis (extension and contraction center axis RA3), and linear rigidity is secured. Bending of the arm section 5 is restored when the arm section 5 is pulled back in the rearward direction. The arm section 5 has a first piece string 51 and a second piece string 52. The first piece string 51 includes a plurality of first pieces 53 that are bendably connected. The first pieces 53 are formed in a substantially flat plate shape. The second piece string 52 includes a plurality of second pieces 54. Each second piece 54 forms a groove frame-like body having an U-shape in transverse section. The second pieces 54 are bendably connected by a connecting shaft of a bottom plate. Bending of the second piece string 52 is restricted at positions at which end faces of side plates of the second pieces 54 butt against each other. At such positions, the second piece string 52 is linearly arranged. A leading first piece 53 of the first piece string 51 and a leading second piece 54 of the second piece string 52 are connected by a head piece 55. For example, the head piece 55 has a shape that integrates the first piece 53 and the second piece 54.

The first and second piece strings 51 and 52 are pressed together and joined when passing between a plurality of rollers 59 that are vertically arranged. As a result of being joined, the first and second piece strings 51 and 52 manifest linear rigidity, and thereby constitute the columnar arm section 5. A drive gear 56 is provided to the rear of the rollers 59. The drive gear 56 is connected to a stepping motor through a decelerator (unshown). A linear gear is formed along the connecting direction at the width center of an inside face of the first piece 53. The linear gears which are adjacent when a plurality of the first pieces 53 are linearly aligned are connected linearly to constitute a long linear gear. The drive gear 56 is meshed with the linear gear of the first piece 53 that is pressed by a guide roller 57. The linear gears that are connected linearly constitute a rack-and-pinion mechanism together with the drive gear 56. When the drive gear 56 rotates forward, the first and second piece strings 51 and 52 are sent forward from the rollers 59. When the drive gear 56 rotates backward, the first and second piece strings 51 and 52 are pulled back to the rear of the rollers 59. The first and second piece strings 51 and 52 that were pulled back are separated between the rollers 59 and the drive gear 56. The separated first and second piece strings 51 and 52 each return to a bendable state. The first and second piece strings 51 and 52 that returned to a bendable state both bend in the same direction (inward) and are vertically housed inside the columnar support section 2. At this time, the first piece string 51 is housed in a substantially aligned state approximately parallel to the second piece string 52.

A wrist section 6 is attached to the tip of the arm section 5. The wrist section 6 includes fourth to sixth joints J4 to J6. The fourth to sixth joints J4 to J6 have three axes of rotation RA4 to RA6 that are orthogonal, respectively. The fourth joint J4 is a torsional rotational joint that rotates on the fourth axis of rotation RA4 that approximately matches the extension and contraction center axis RA3. An end effector is oscillatingly rotated by rotation of the fourth joint J4. The fifth joint J5 is a bending rotational joint that rotates on the fifth axis of rotation RA5 perpendicular to the fourth axis of rotation RA4. The end effector is tilted and rotated to front and rear by rotation of the fifth joint J5. The sixth joint J6 is a torsional rotational joint that rotates on the sixth axis of rotation RA6 perpendicular to the fourth axis of rotation RA4 and the fifth axis of rotation RA5. The end effector is axially rotated by rotation of the sixth joint J6.

The end effector is mounted to an adaptor 7 that is provided at a lower part of the rotating section of the sixth joint J6 of the wrist section 6. The end effector is a portion that has a function that allows the robot to directly act on a work piece object (work piece), and for example various tools exist in accordance with a required task, such as a gripping portion, a vacuum suction portion, a nut fastening tool, a welding gun, and a spray gun. The end effector is moved to a given position by the first, second and third joints J1, J2 and J3, and is disposed in a given posture by the fourth, fifth and sixth joints J4, J5 and J6. In particular, the length of the extension and retraction distance of the arm section 5 of the third joint J3 allows the end effector to reach objects in a wide range from a position close to the base 1 to a position far from the base 1. Characteristic features of the third joint J3 with respect to which the third joint J3 differs from a conventional linear motion joint are the linear extension and retraction motions realized by the linear extension and retraction mechanism constituting the third joint J3, and the length of the extension and retraction distance thereof.

The first joint J1 has a cylindrical or annular rotary pedestal 23. The rotary pedestal 23 is connected to the base 1 of the columnar support section 2. A rotary frame 24 that is rotatably supported on the rotary pedestal 23 is a cylindrical or annular shape. The first and second piece strings 51 and 52 that were pulled back are housed in an inner hollow of the rotary frame 24. A rotary shaft of an unshown motor is connected directly or indirectly through a motive power transmission mechanism to the rotary frame 24.

A pair of side frames 50 as a fixed section (support body) of the second joint J2 are mounted on the rotary frame 24. A drum body 60 as a rotating section that also serves as a motor housing is supported by the pair of side frames 50. One end of the drum body 60 is pivotally supported in a rotatable manner by one of the side frames 50. A motor unit that includes a motor and a gearbox is fixed inside the drum body 60. An output shaft (drive shaft) of the motor unit is fixed to the other side frame 50. The drum body 60 rotates on the axis of rotation RA2 accompanying rotation of the output shaft.

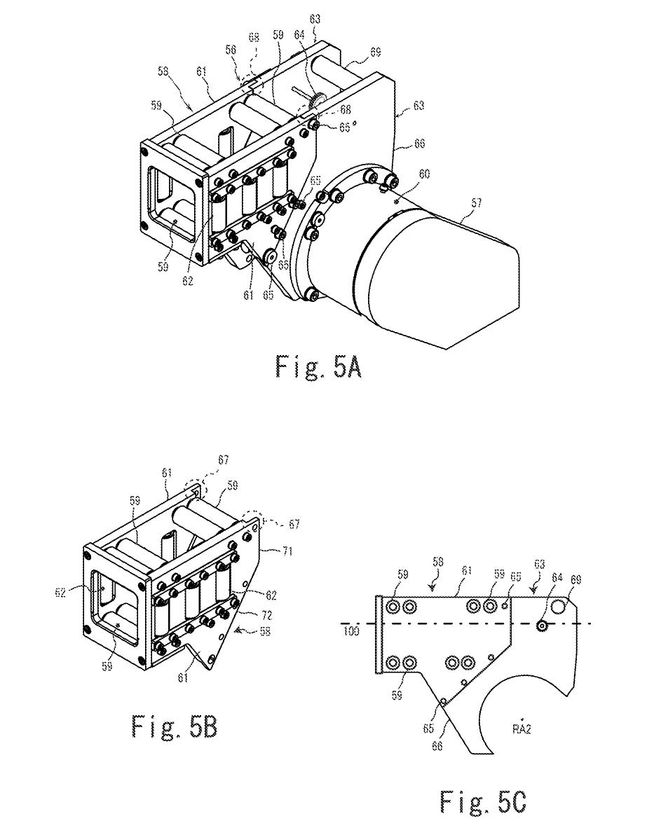

The sending-out mechanism 56 is mounted on the peripheral surface of the drum body 60. The sending-out mechanism 56 rotates accompanying axial rotation of the drum body 60, and the arm section 5 that is supported by the sending-out mechanism 56 rotates upward and downward. As illustrated in FIGS. 5A to SC, the sending-out mechanism 56 includes a plurality of upper and lower rollers 59, a plurality of left and right rollers 62, a drive gear 64, and a guide roller 69. Together with the first and second piece strings 51 and 52, the sending-out mechanism 56 is a main structure of the linear extension and retraction mechanism (third joint J3). For example, eight upper and lower rollers 59 are provided, with four of the rollers 59 arranged on the upper side and the remaining four rollers 59 arranged on the lower side. The four rollers 59 that are on the upper side and lower side, respectively, are arranged in a line so that their axes of rotation are parallel with each other. The four rollers 59 on the upper side are separated from the four rollers 59 on the lower side by a distance that is equivalent to the total thickness of the joined first and second pieces 53 and 54. By this means, the first and second pieces 53 and 54 can be joined, firmly sandwiched from the top and bottom, and supported movably to front and rear by the upper and lower rollers 59. For example, six left and right rollers 62 are provided, with three of the rollers 62 arranged on the left side and the remaining three rollers 62 arranged on the right side. The three rollers 62 that are on the left side and right side, respectively, are linearly arranged in parallel with each other in a direction perpendicular to the axis of rotation. The three rollers 62 on the left side are separated from the three rollers 62 on the right side by a distance that is equivalent to the width of the first and second pieces 53 and 54. By this means, the first and second pieces 53 and 54 are firmly sandwiched from the left and right sides, and supported movably to front and rear.

To ensure that the rollers 59 and 62 do not damage the first and second pieces 53 and 54 that are made of, for example, aluminum, the rollers 59 and 62 are cylindrical bodies made of, for example, a self-lubricating resin having a degree of hardness that is lower than the degree of hardness of aluminum and also having low durability such as polyacetal (POM), polyamide (PA) or polytetrafluoroethylene (PTFE; fluorocarbon resin), or are cylindrical bodies made of aluminum whose outer circumference is coated with such a self-lubricating resin. Accordingly, the durable period of the rollers 59 and 62 is shorter than the durable period of the first and second pieces 53 and 54, and the replacement frequency is comparatively high.

The drive gear 64 and the guide roller 69 are both arranged to the rear of the rollers 59 and 62. The guide roller 69 is separated from the drive gear 64 by a distance that is equivalent to the thickness of the first piece 53. The respective first pieces 53 are pressed against the drive gear 64 by the guide roller 69. The drive gear 64 meshes with a linear gear formed in the inner face of the first piece 53. A rotary shaft of the drive gear 64 is connected to the drive shaft of an unshown motor, and when the motor rotates forward the drive gear 64 sends out the first pieces 53 in the forward direction, and when the motor rotates backward the drive gear 64 pulls back the first pieces 53 in the rearward direction.

As described above, the replacement frequency of the rollers 59 and 62 is comparatively high compared to the first and second pieces 53 and 54. The relative positions of the drive gear 64 and the guide roller 69 that sandwich the first pieces 53 that align in a straight line are required to be accurate with respect to the rollers 59 and 62, and therefore conventionally the sending-out mechanism 56 including the rollers 59 and 62, the drive gear 64 and the guide roller 69 has been constructed as one body in a single frame. In such a conventional configuration, the sending-out mechanism 56 is fixed to the peripheral surface of the drum body 60 of the up/down section 4, and the drum body 60 of the up/down section 4 is arranged at a complex location in the internal structure, such as a side frame 57. In addition, the drive gear 64 and the guide roller 69 sandwich the first pieces 53. Accordingly, in order to replace the rollers 59 and 62, it has been necessary to perform operations to take out the entire sending-out mechanism 56 from the drum body 60 of the up/down section 4, and disassemble the first and second piece strings 51 and 52 and extract the first and second piece strings 51 and 52 from the sending-out mechanism 56, and thus the work pieceability has been extremely low.

In the present embodiment, to improve the work pieceability when replacing the rollers 59 and 62, in the sending-out mechanism 56, a roller unit 58 including the rollers 59 and 62, and a drive unit 63 including the drive gear 64 and the guide roller 69 are configured as structurally separate bodies. The drive unit 63 is fixed to the drum body 60 of the up/down section 4. The roller unit 58 including the rollers 59 and 62 is configured to be detachably attachable to the drive unit 63. When it is necessary to perform maintenance, such as replacement, of the rollers 59 and 62, the roller unit 58 is detached from the drive unit 63 in a state in which the drive unit 63 remains fixed to the drum body 60 of the up/down section 4. Since the roller unit 58 can be detached while maintaining a state in which the drive gear 64 and the guide roller 69 of the drive unit 63 are sandwiching the first pieces 53, there is no necessity to disassemble the first and second piece strings 51 and 52. By detaching the wrist section 6 from the tip of the arm section 5, the arm section 5 can be inserted through the rollers 59 and 62 of the roller unit 58, the roller unit 58 can be separated from the arm section 5, and the roller unit 58 alone can be taken out independently and the rollers 59 and 62 that are damaged can be easily replaced.

With respect to the structure of the roller unit 58, a shaft of each of the rollers 59 is retained by a pair of opposing side plates 61 by being screwed into the side plates 61 from both sides. A notch is formed in a rectangular shape in each of the side plates 61, and the left and right rollers 62 are fitted into the respective notches, and the shaft of each roller 62 is fixed therein by screwing. The drive unit 63 is also retained in a pair of side plates 66 by the shaft of the guide roller 69 being screwed therein from both sides, and the drive gear 64 is pivotally supported below the guide roller 69, with a distance between the drive gear 64 and the guide roller 69 being equivalent to the thickness of the first piece 53. The respective side plates 66 are formed to have the same thickness as the side plate 61. The roller unit 58 and the drive unit. 63 are joined in a halving-joint shape in which level differences 67 that are mutually different at the rear edge of the side plate 61 of the roller unit 58 and the front edge of the side plate 66 of the drive unit 63 mesh, and at this joining portion 68 the side plate 61 of the roller unit 58 is fastened by screws 65 at a plurality of places, four places in this example, to the side plate 66 of the drive unit 63. The level difference 67 at the rear edge of the side plate 61 of the roller unit 58 is formed to be one-half of the thickness of the side plate 61, and the level difference at the front edge of the side plate 66 of the drive unit. 63 is formed to be one-half of the thickness of the side plate 66, and by this means the thickness of the joining portion 68 is configured to be equal to the thickness of the side plate 61 of the roller unit 58 and the side plate 66 of the drive unit 63.

By joining the roller unit 58 and the drive unit 63 in a halving-joint shape and fastening the joining portion 68 with the screws 65, the roller unit 58 can be firmly joined to the drive unit 63 without wobbling therebetween, and furthermore, the roller unit. 58 can be simply detached from the drive unit 63 by unfastening the screws 65 at eight places in total on the two sides.

The side plates 61 of the roller unit. 58 are each formed in a tapered shape in which the width gradually narrows in the rearward direction. The rear edges of the side plates 61 of the roller unit 58 are joined to the front edges of the side plates 66 of the drive unit 63 at two sides 71 and 73 that intersect at, for example, 135 degrees, as an obtuse angle. One of the joining sides, the side 71, is perpendicular to a center line 100 of a region that the arm section 5 is inserted through that is defined by a row of the rollers 59 on the upper side and a row of the rollers 62 on the lower side. The other of the joining sides, the side 73, inclines at an acute angle, for example, 45 degrees, with respect to the center line 100.

By the roller unit 58 being joined at the two sides 71 and 73 that form an obtuse angle with respect to the roller unit 58, the work pieceability, particularly an alignment operation, when mounting the roller unit 58 to the drive unit 63 improves, and the rollers 59 and 62 can be precisely disposed at the mounting position, that is, the rollers 59 and 62 can be accurately disposed at a prescribed relative position with respect to the drive gear 64 and the guide roller 69.

As described above, according to the present embodiment the work pieceability when replacing rollers constituting part of a linear extension and retraction mechanism of a robot arm mechanism is improved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

1 . . . BASE, 2 . . . ARM SECTION, 3 . . . END EFFECTOR, J1, J2, J4, J5, J6 . . . ROTATIONAL JOINT, J3 . . . LINEAR EXTENSION AND RETRACTION JOINT (LINEAR. EXTENSION AND RETRACTION MECHANISM), 53 . . . FIRST PIECE, 54 . . . SECOND PIECE, 56 . . . SENDING-OUT MECHANISM, 58 . . . ROLLER UNIT, 59, 62 . . . ROLLER, 61, 66 . . . SIDE PLATE, 63 . . . DRIVE UNIT, 64 ...DRIVE GEAR, 67 . . . LEVEL DIFFERENCE, 68 . . . JOINING PORTION, 69 . . . GUIDE ROLLER.

1. A robot arm mechanism in which a columnar support section having a turning rotational joint is supported on a base, an up/down section having an upward/downward rotational joint is mounted on the columnar support section, a linear extension and retraction mechanism comprising an arm section having linear elasticity is provided in the up/down section, a wrist section to which an end effector is attachable is mounted at a tip of the arm section, and at least one rotational joint for changing a posture of the end effector is mounted in the wrist section, wherein
the linear extension and retraction mechanism comprises:
a plurality of first pieces having a flat-plate shape, the first pieces being bendably connected to each other at front and rear ends,
a plurality of second pieces having a cross-sectional U-shaped groove frame shape, the second pieces being bendably connected to each other at front and rear ends of a bottom plate,
a head section that joins a leading first piece of the plurality of first pieces and a leading second piece of the plurality of second pieces, with the first and second pieces becoming linearly rigid and constituting the arm section when the first and second pieces are joined, and the first, and second pieces returning to a bent state when separated from each other, and
a sending-out mechanism having a plurality of rollers that firmly sandwich the first and second pieces to secure a joined state of the first and second pieces and that support the first and second pieces movably to front and rear, and a drive gear that is meshed with a linear gear of the separated first pieces rearward of the rollers and that sends out the first pieces to the front and pulls back the first pieces to the rear;
wherein the sending-out mechanism is composed of separate bodies which are a roller unit comprising the rollers, and a drive unit comprising the drive gear, with the drive unit being fixed to a rotating section of the up/down section, and the roller unit being configured to be detachably attachable to the drive unit.

2. The robot arm mechanism according to claim 1, wherein a side plate comprising the roller unit and a side plate comprising the drive unit are joined in a halving-joint shape in which mutually different level differences mesh, and the side plate of the roller unit and the side plate of the drive unit are fastened with screws at a joining portion.

3. The robot arm mechanism according to claim 2, wherein a thickness of the joining portion is equivalent to a thickness of another portion of the side plate of the roller unit and another portion of the side plate of the drive unit.

4. The robot arm mechanism according to claim 2, wherein the side plate of the roller unit is formed in a tapered shape.

5. The robot arm mechanism according to claim 2, wherein the roller unit is joined to the drive unit at two sides that intersect at an obtuse angle.

6. A linear extension and retraction mechanism, comprising:
a plurality of first pieces having a flat-plate shape, the first pieces being bendably connected to each other at front and rear ends;
a plurality of second pieces having a cross-sectional U-shaped groove frame shape, the second pieces being bendably connected to each other at front and rear ends of a bottom plate;
a head section that joins a leading first piece of the plurality of first pieces and a leading second piece of the plurality of second pieces, with the first and second pieces becoming linearly rigid when joined, and the first and second pieces returning to a bent state when separated from each other; and
a sending-out mechanism having a plurality of rollers that firmly sandwich the first and second pieces to secure a joined state of the first and second pieces and that support the first and second pieces movably to front and rear, and a drive gear that is meshed with a linear gear of the separated first pieces rearward of the rollers and that sends out the first pieces to the front and pulls back the first pieces to the rear;
wherein the sending-out mechanism is composed of separate bodies which are a roller unit comprising the rollers, and a drive unit comprising the drive gear, with the roller unit being configured to be detachably attachable to the drive unit.
